(19) United States
(12) Patent Application Publication
(10) Pub. No.: US 2011/0106589 A1
(43) Pub. Date: May 5, 2011

(54) DATA VISUALIZATION PLATFORM FOR SOCIAL AND TRADITIONAL MEDIA METRICS ANALYSIS

(76) Inventors: James Blomberg, Shelton, CT (US); Ingatius Anandappa, Fairfield, CT (US); Sean Morton, Shelton, CT (US); Murali Narasimman, Shelton, CT (US); Michael Krebs, Danbury, CT (US); Li Ye Chen, Shelton, CT (US); Britta Barrett, Wauwatosa, WI (US); Jeffrey DeMarrais, Fairfield, CT (US); Simon Langford, London (GB)

(21) Appl. No.: 12/611,407

(22) Filed: Nov. 3, 2009

(51) Int. Cl. G06Q 10/00; G06T 11/20

(52) U.S. Cl. 705/7.39; 705/347; 345/440; 705/7.11

(57) ABSTRACT

According to some embodiments, data may be received from a plurality of remote data sources. The received data may be, for example, associated with a plurality of social and traditional media sources. The received data may be aggregated based on an association with an entity and stored. At least two superimposed graphs may then be automatically provided on a user display, including (i) a first graph having an x-axis representing time and a y-axis representing an amount of social networking activity in the aggregated data and (ii) a second graph having an x-axis shared with the first graph and a y-axis representing a financial value associated with the entity.

### BACKGROUND

In some cases, an entity, such as a corporation, may be interested in monitoring the public's perception of itself or of a product or service it provides. For example, the quantity and tone of public discussion associated with the entity on social media, social networking, traditional media and other online sites and data repositories (referred to herein as “media sources”) may be of particular interest. As used herein, the term “social media” may refer to any web site, web application, online data repository, or online media outlet wherein members of the public share and/or exchange information with other people. By way of examples only, social media sources might include social networking sites, MySpace®, Facebook®, Twitter®, personal and organizational blogs, YouTube®, and other public online collaborative media.

The amount of such information, including information available via social networking webs on the Internet, can be vast. Moreover, there are many different types of information sources that may be of interest. As a result, monitoring, tracking and mining this data can be a time consuming, expensive, error-prone, and a difficult task. In addition, the results of such monitoring can include a confusing amount and array of information that can be difficult to comprehend, analyze, evaluate, correlate and/or act upon. For example, it might be difficult to understand why user posts or comments about an entity rose above (or fell below) an average level on a particular day, and how a significant amount of social media attention associated with a public company may be correlated with the company's stock performance.

### SUMMARY

According to some embodiments, data may be received from a plurality of remote data sources, the received data being associated with a plurality of social, traditional media and data sources. The received data may be aggregated and stored based on particular associations with an entity. At least two superimposed graphs may be automatically displayed to a user on a user display, including (i) a first graph having an x-axis representing time and a y-axis representing an amount of activity in the aggregated data and (ii) a second graph having an x-axis shared with the first graph and a y-axis representing a financial value associated with the entity.

Other embodiments may include: means for receiving data from a plurality of remote data sources, the received data being associated with a plurality of social and traditional media sources; means for aggregating the received data based on an association with an entity; means for storing the aggregated information; and means for automatically displaying to a user at least two superimposed graphs on a user display, including (i) a first graph having an x-axis representing time and a y-axis representing an amount of activity in the aggregated data and (ii) a second graph having an x-axis shared with the first graph and a y-axis representing a financial value associated with the entity.

A technical effect of some embodiments of the invention is an improved and automated ability to interpret and share information associated with social and traditional media sources. With this and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a block level diagram of a system according to some embodiments.

FIG. 2 illustrates a method according to some embodiments of the present invention.

FIG. 3 illustrates a graphical user interface display according to some embodiments.

FIG. 4 illustrates a more detailed display of information according to some embodiments.

FIG. 5 illustrates a display including social networking information according to some embodiments.

FIG. 6 is a block diagram of a system in accordance with some embodiments.

FIG. 7 illustrates a system architecture for a visualization platform according to some embodiments.

FIG. 8 is a block diagram of a visualization platform apparatus in accordance with some embodiments of the present invention.

FIG. 9 is a tabular view of a portion of a display database in accordance with some embodiments of the present invention.

FIG. 10 illustrates a display including a news article in accordance with some embodiments.

FIG. 11 illustrates access level display in accordance with some embodiments.

FIG. 12 illustrates a user preference display in accordance with some embodiments.

FIG. 13 illustrates a display that might be associated with a user alert in accordance with some embodiments.

FIG. 14 illustrates a display that might be associated with a trend analysis in accordance with some embodiments.

FIG. 15 illustrates a display that might be associated with campaign correlations in accordance with some embodiments.

FIG. 16 illustrates a search display in accordance with some embodiments.

### DETAILED DESCRIPTION

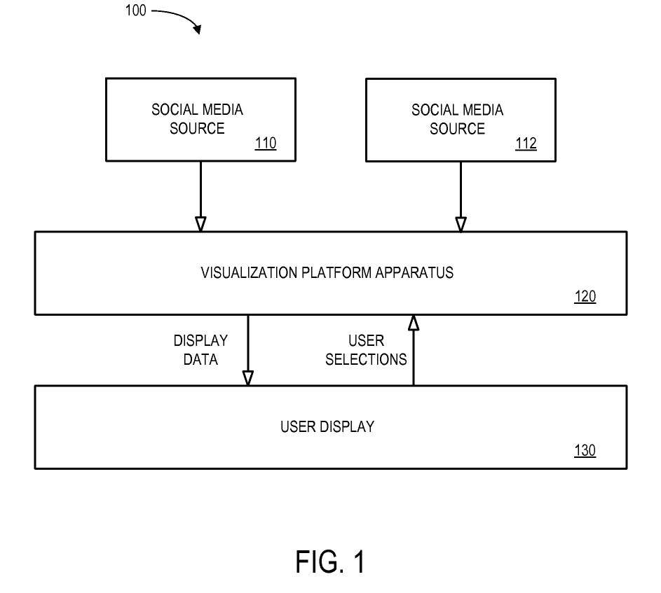

To address some of the problems described in the background section of this application, a visualization application and/or apparatus may be provided. For example, FIG. 1 is block diagram of a system 100 in accordance with some embodiments. In particular, a visualization tool or platform 120 may receive information from a number of remote social media sources 110, 112 (including, for example, data associated with social networking sites). The visualization platform 120 may also exchange data with one or more remote user displays 130. As used herein, a device may be “remote” from the visualization platform 120 in that it is physically located distant from the visualization platform 120 and/or in that it communicates with the visualization platform 120 via one or more Internet and/or intranet communication networks and/or protocols. The visualization platform 120, social media sources 110, 112, and user display 130 may then operate in accordance with any of the embodiments described herein.

According to some embodiments, the visualization platform 120, social media sources 110, 112, and user display 130 facilitate an automated transfer of information associated with one or more social media sources. As used herein the term “automated” indicates that at least some part of a step associated with a process or service is performed with little or no human intervention. By way of examples only, the business systems 110, 112 and/or user display 130 might be associated with a Personal Computer (PC), a notebook computer, a server, an Internet data “cloud”, a workstation, and/or a Personal Digital Assistant (PDA). The visualization platform 120 might be associated with, for example, a server, an enterprise application, and/or a database.

Note that the social media sources 110, 112 might be associated with either the social media source web site or a third-party service that collects information (such as Omniture®, Meltwater®, Radian6®, Google Analytics®, Factiva®, and other private, proprietary collaborative and analytical media systems).

Any of the devices described in connection with the system 100 might, according to some embodiments, exchange information via a communication network and use specific communication network protocols. As used herein, devices (including those associated with the visualization platform 120, social media sources 110, 112, and user display 130) may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, an Ethernet network, a wireless LAN network, a mobile/cellular network (GSM, GPRS, EDGE, etc), a WiMAX network, a satellite network (e.g., CDMA, FDMA, etc), and/or an Internet Protocol (TCP/IP) network such as the Internet, an intranet, an extranet. Note that any devices described herein may communicate via one or more such communication networks.

The devices of FIG. 1 might, according to some embodiments, be accessible via a Graphical User Interface (GUI). The GUI might be associated with a data exchange layer application and may be used, for example, to dynamically display and receive information in connection with social media sources and/or a configuration of business systems 110, 112, the visualization platform 120, and/or the user display 130.

Although a single visualization platform 120 and user display 130 are shown in FIG. 1, any number of such devices and systems may be included. Moreover, various devices described herein might be combined or co-located according to embodiments of the present invention.

The visualization platform 120 may include a communication device (e.g., a port) to receive data from the plurality of social media sources 110, 112 and/or the user display 130. The visualization platform 120 may further include a processor coupled to the communication device and a storage device in communication with the processor storing instructions adapted to be executed by the processor to perform a method in accordance with any of the embodiments described herein. For example, the visualization platform 120 may aggregate and/or store information that is received from the social media sources 110, 112. The visualization platform 120 may also receive user selections from the user display 130 (e.g., his or her display preferences) and transmit display data to the user display 130. For example, two superimposed graphs might be automatically provided on the user display, including (i) a first graph having an x-axis representing time and a y-axis representing an amount of social networking activity in the aggregated data and (ii) a second graph having an x-axis shared with the first graph and a y-axis representing a financial value associated with the entity.

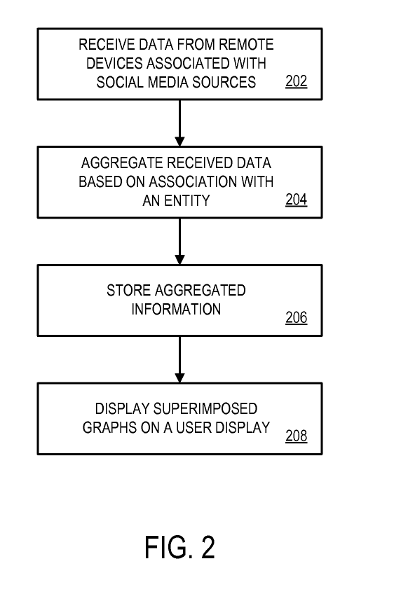

FIG. 2 illustrates one method that might be performed, for example, by the visualization platform 120 described with respect to FIG. 1 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At 202, data may be received from a plurality of remote data sources, the received data being associated with a plurality of social media sources. For example, a visualization platform might receive metrics information about Facebook® posts and/or comments and Twitter® updates. Note that other types of information may also be received, such as stock price information, news stories, and/or press releases. Further note that the received data might be associated with formal news sources and publications, social media sites, social network posts, social network updates, blog entries, user comments, links, or user connections (e.g., Facebook® “friends”).

At 204, the received data may be aggregated based on an association with an “entity.” The entity might comprise, for example, a corporation or sub-unit of a corporation. As other examples, an entity might be associated with a governmental body such as the Internal Revenue Service (IRS), an educational institution such as a university, a sports team, a product, and/or an individual (e.g., a celebrity). The aggregated information may be stored at 206 (e.g., into a database or table for later retrieval) and/or shown on a user display in substantially real-time by use of data streams.

At 208, superimposed graphs may be displayed on a user display. For example, a visualization platform might automatically display to a user at least two superimposed graphs, including (i) a first graph having an x-axis representing time and a y-axis representing an amount of activity in the aggregated data and (ii) a second graph having an x-axis shared with the first graph and a y-axis representing a financial “value” associated with the entity. The value might be associated with, for example, a stock price.

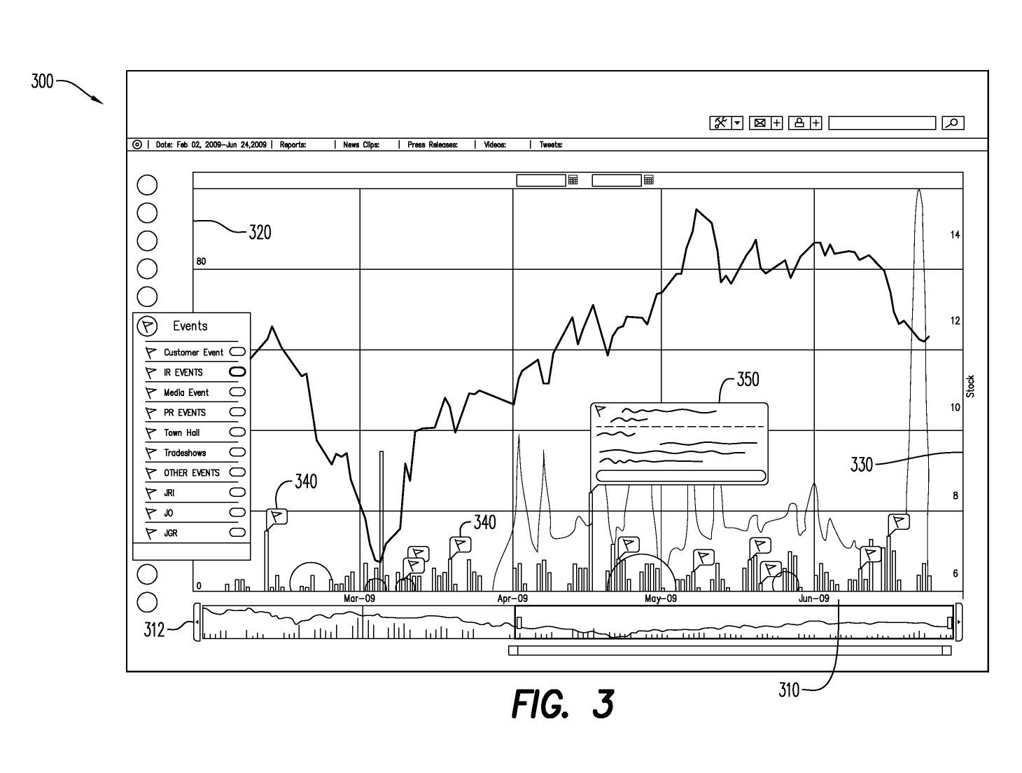

Consider, by way of example, FIG. 3 which illustrates a graphical user interface display 300 according to some embodiments. In this example, a first graph includes an x-axis 310 representing time and a y-axis 320 representing a number of social media sources that mention a particular corporation or the volume of such mentions of a particular corporation. Note that a user might access controls 312 to adjust, select, and/or zoom into/out of various time periods. A second graph is superimposed on the first graph, shares the time x-axis 310 with the first graph, and has a y-axis 330 associated with a stock price for the corporation. According to some embodiments, a third graph is superimposed on the first and second graphs, the third graph having the same shared x-axis 310 and a y-axis associated with, by way of examples only, a number of press releases or a volume of stock trades associated with the entity.

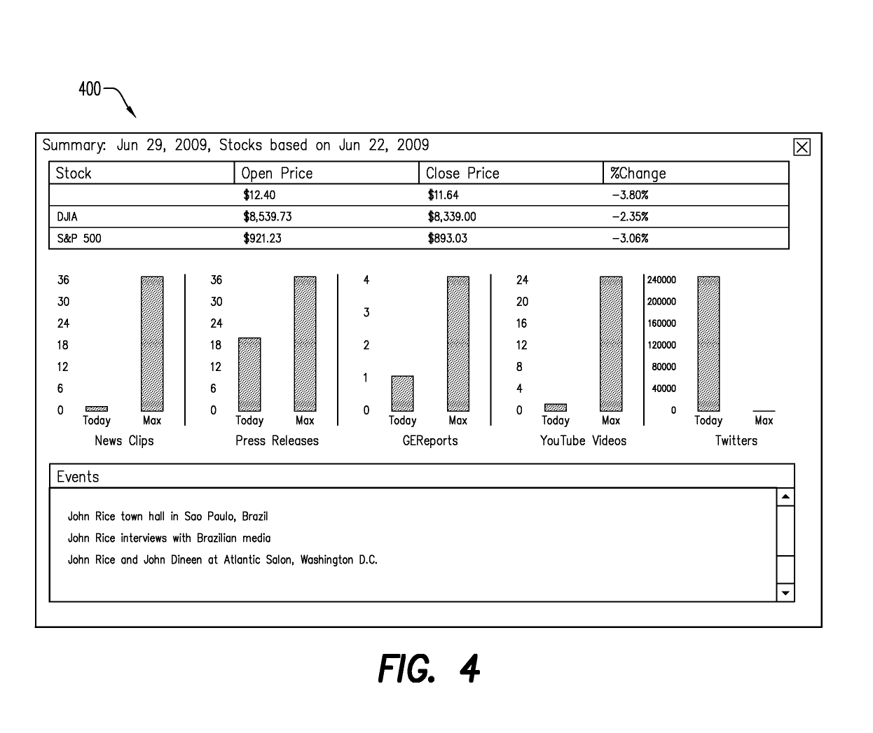

Moreover, according to some embodiments, at least one event indicator 340 is superimposed on the first and second graphs. The event indicators 340 might be flags or pins associated with, for example, press releases (e.g., announcing a new product or service), news stories, web casts, financial reports, marketing campaign, stock transaction/issuance/buyback and/or trade shows. According to some embodiments, a user might select an event indicator 340 to receive a more detailed display 350 about the event. Similarly, a user might select a portion of the display 300 to receive additional information. For example, FIG. 4 illustrates a more detailed display 400 of information according to some embodiments.

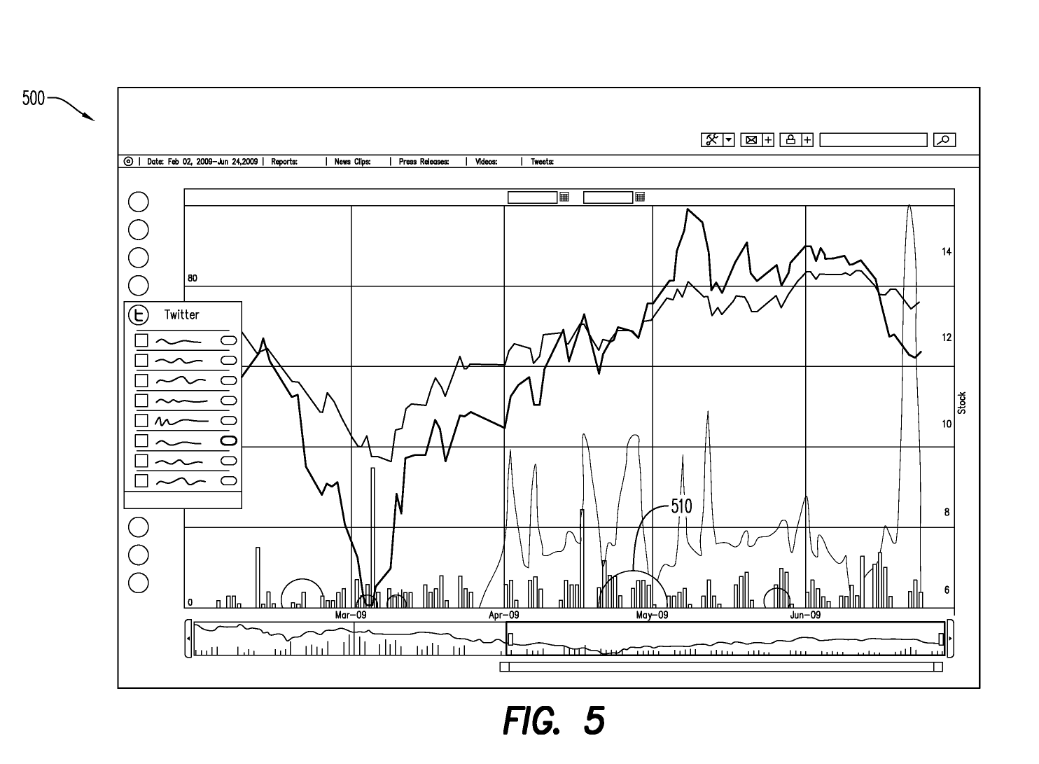

FIG. 5 illustrates a display 500 including social networking information according to some embodiments. According to some embodiments, a visible area—such as a shaded semi-circle 510—may be overlaid on the first and second graphs. The size of the semi-circle 510 may be associated with, by way of example, a number of comments, a number of web page hits, a number of links, and/or a number of social networking connections. Moreover, according to some embodiments, an element of received data may be weighted based on a number of user-connections associated with the element (e.g., a post from a person with a large number of Facebook® friends might be considered more important as compared to a post from a person with relatively fewer friends).

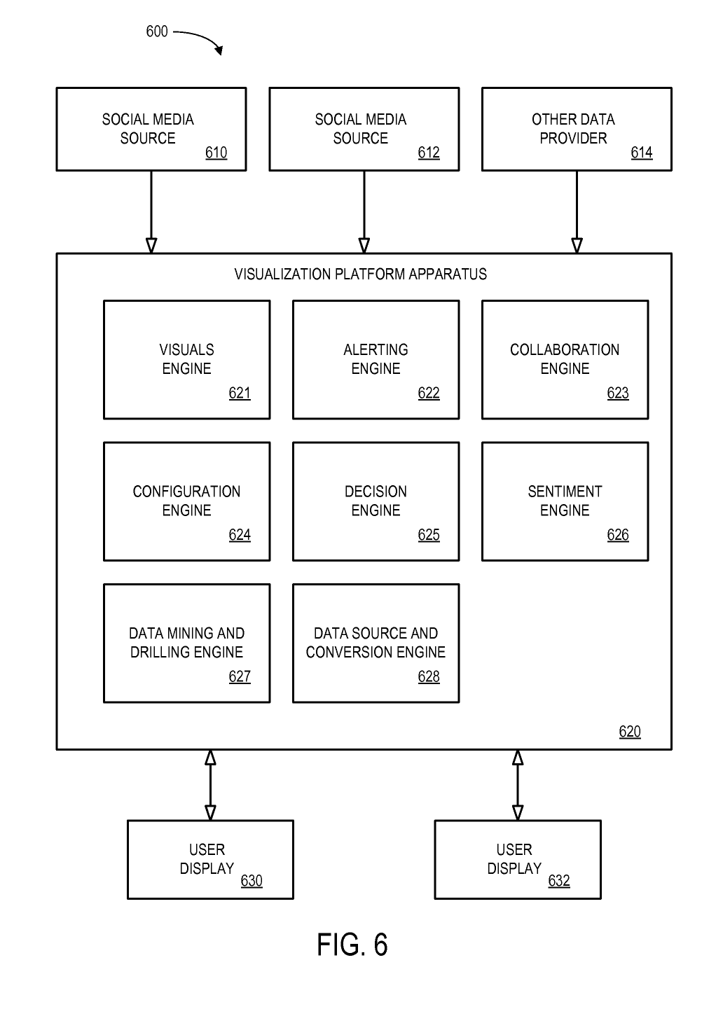

FIG. 6 is a block diagram of a system 600 in accordance with some embodiments. In particular, the visualization platform apparatus 620 may receive information from social media sources 610, 612 as well as other data providers (e.g., about the stock market, press releases, and/or news articles). The visualization platform apparatus 620 may then arrange for appropriate displays to be provided for a number of different user displays 630, 632.

The visualization platform apparatus 620 may include a visuals engine 621 to provide data visualization over time and across multiple social media measurements. Each measurement might appear in different shapes, sizes, and/or colors to not only clearly distinguish it from other measurements, but to also provide an intuitive description of magnitude, duration, frequency and/or trend. The visuals engine 621 may, for example, be capable of clearly overlaying multiple social media measurements in one screen for any time period. It may also able to zoom in and out across different time scales simply by double-clicking on the area of interest.

Besides the visualization of social media trends, the visuals engine 621 may help enables in-depth data review for various social media aspects, such as viewing YouTube® videos of a specific campaign, reading commentary from Twitter® members over smart-grid technology, viewing total press releases on a given day, reviewing in-depth articles from Factiva®, etc. The visuals engine 621 might help provide a linkage between an in-depth source and an overall social media trend and timeframe. Note that an open and modular aspect of the visuals engine 621 may help turn on and off combinations of different visualizations to improve readability and understanding.

The visualization platform apparatus 620 may also include a configuration engine 624, such as a flexible management and/or configuration component that lets users save preferences and administrators manage roles and security. A user might, for example, save his or her preferences for social media visualizations and/or add and remove events, publications, and campaigns. Administrators might fine-tune security by managing user roles. According to some embodiments, the configuration engine 624 may be integrated with other organizational directory systems.

The visualization platform apparatus 620 may also include an alerting engine 622 that works together with a decision engine 625 to alert interested users to specific trends and user-defined changes in social media measurements. It may be capable of sending alerts using various mediums, such as email, desktop alerts, and instant messaging. The decision engine 625 may provide statistical analysis of social media measurements, and the user might be able to define and set alerts for specific statistical trends within and between social media measurements.

The visualization platform apparatus 620 may also include a collaboration engine 623 coupled to the visuals engine 621, alerting engine 622, and/or decision engine 625 to provide cross-organization collaboration on social media trends, data, and commentary. Users might, for example, send exact social media visualizations to another user, define a start and end of a campaign, and/or insert commentary on a social media measurement associated with a timeframe.

The visualization platform apparatus 620 may also include a sentiment engine 626 coupled to the visuals engine 621, alerting engine 622, and/or decision engine 625 to provide sentiment analysis from multiple social media sources, and/or to leverage weighting and viewership to further refine the “priorities” of different sentiments.

The visualization platform apparatus 620 may also include a data mining and drilling engine 627 coupled to the visuals engine 621 to provide in-depth data sources for social media trends (tying different in-depth sources such as articles to specific trends and timeframes) and/or to provide users an ability to drill down into as much details as desired. The data mining and drilling engine 627 may also provide search functionality to let a user find targeted information about social media terms and/or topics. According to some embodiments, search results may be grouped by different social media measurements and sources.

The visualization platform apparatus 620 may also include a data source & conversion engine to provide a structured social media data source framework, to enable users to “plug-in” various sources of data, such as Omniture®, Radian6®, Meltwater®, Google Analytics®, custom press releases, Twitter® commentary, and/or YouTube® traffic reports.

Thus, some embodiments of the system 600 described herein may help with a number of different business, communications, and/or marketing challenges for an organizations. For example, the system 600 may help evaluate the effectiveness of marketing and communications campaigns of a company and help executives understand social media trends (including micro, macro and anomalous trends) regarding a company. The system 600 may also help enable cross-organization collaboration on social media trends, communications and marketing campaigns for a company and/or help obtain competitive analysis of similar companies (from social media perspective). The system 600 may let a user see the “big picture” and provide in-depth drill-down social media measurements, reports, and data for a company to help the user understand public sentiment regarding a company over specific campaigns, advertising, technology, and/or actions. The system 600 may further let a user obtain rapid alerts of statistically significant changes in social media landscape through email, Short Message Service (“SMS”) text, Multimedia Messaging Services (MMS), instant messaging, blog posts, Twitter posts, and/or desktop notification mediums. Moreover, the system 600 may help a user understand different degrees of “importance” and “impact-level” assigned to different social media sources as he or she view social media trends from a combination of diverse sources, rather than a single source.

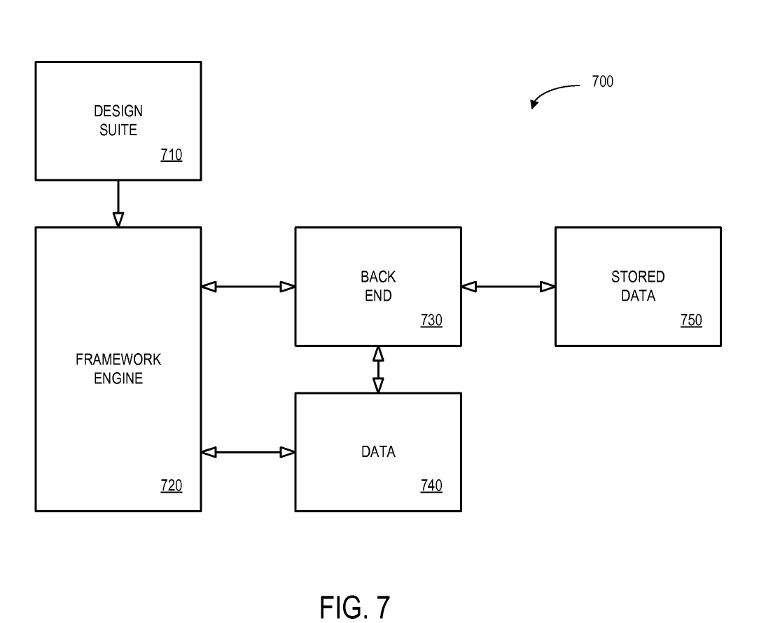

FIG. 7 illustrates a system architecture 700 for a visualization platform according to some embodiments. The architecture 700 includes a design suite 710 (e.g., associated with Flash®, SilverLight®, and Photoshop®) that provides a design to a framework engine 720. The framework engine 720 executes the design at the front end and exchanges information with a back end 730 and data 740 (e.g., external applications and/or social media sources) using XML, SOAP, and other common, standard Internet—as well as proprietary data formats. The back end 730 might, for example, facilitate the storage and retrieval of stored data 750 (e.g., associated with a MySQL, Oracle, MSSQL databases and/or other RDMS or querying mechanism).

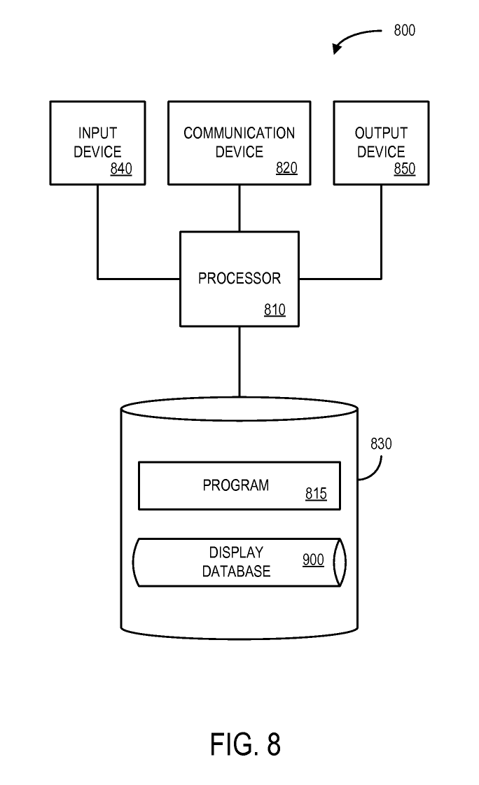

FIG. 8 is a block diagram of a visualization platform apparatus 800 in accordance with some embodiments of the present invention. The apparatus 800 might, for example, comprise a platform or engine similar to the visualization platform 120 illustrated in FIG. 1. The apparatus 800 comprises a processor 810, such as (but in no way limited to) one or more INTEL® Pentium® processors, coupled to a communication device 820 configured to communicate via a communication network (not shown in FIG. 8). The communication device 820 may be used to exchange information with remote business systems and destination devices.

The processor 810 is also in communication with an input device 840. The input device 840 may comprise, for example, a keyboard, a mouse, or computer media reader. Such an input device 840 may be used, for example, to enter configuration and/or management information about user visualization platform preferences. The processor 810 is also in communication with an output device 850. The output device 850 may comprise, for example, a display screen or printer. Such an output device 850 may be used, for example, to provide reports and/or display information associated with social media sources.

The processor 810 is also in communication with a storage device 830. The storage device 830 may comprise any appropriate information storage device, including combinations of magnetic storage devices (e.g., hard disk drives), optical storage devices, and/or semiconductor memory devices such as Random Access Memory (RAM) devices and Read Only Memory (ROM) devices. The storage device 830 stores a program 815 for controlling the processor 810. The processor 810 performs instructions of the program 85, and thereby operates in accordance any embodiments of the present invention described herein. For example, the processor 810 may aggregate and/or store information that is received from social media sources. The processor 810 may also receive user selections from a user display (e.g., his or her display preferences) and transmit display data to the user display. For example, two superimposed graphs might be automatically provided on the user display, including (i) a first graph having an x-axis representing time and a y-axis representing an amount of social networking activity in the aggregated data and (ii) a second graph having an x-axis shared with the first graph and a y-axis representing a financial value associated with the entity.

As used herein, information may be “received” by or “transmitted” to, for example: (i) the visualization platform apparatus 800 from other devices; or (ii) a software application or module within the visualization platform apparatus 800 from another software application, module, or any other source.

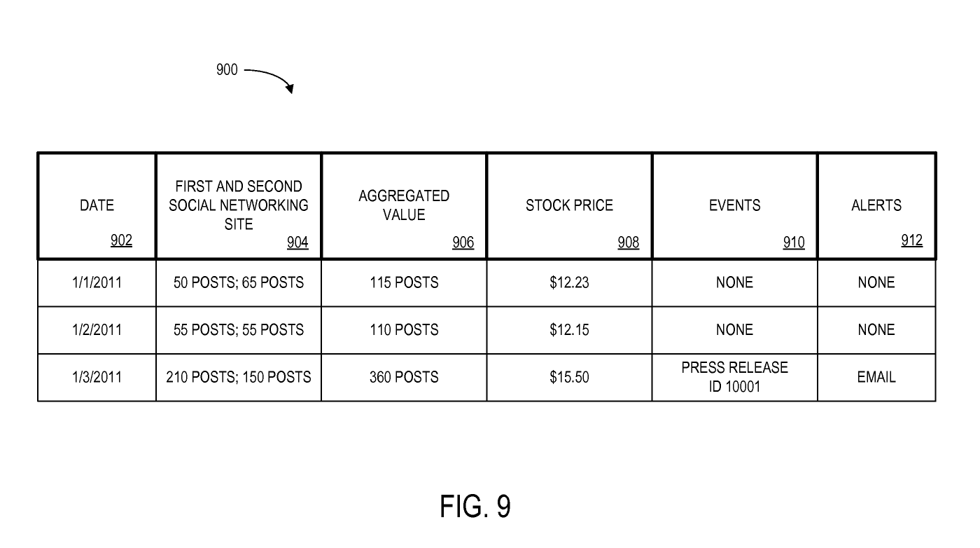

As shown in FIG. 8, the storage device 830 also stores the display database 900. One example of such a database 900 that may be used in connection with the visualization platform apparatus 800 will now be described in detail with respect to FIG. 9. The illustration and accompanying descriptions of the database presented herein are exemplary, and any number of other database arrangements could be employed besides those suggested by the figures. For example, different databases associated with different types of social media sources might be stored at the apparatus 800.

FIG. 9 is a tabular view of a portion of the display database 900 in accordance with some embodiments of the present invention. The table includes entries associated with intelligent electronic devices. The table also defines fields 902, 904, 906, 908, 910, 912 for each of the entries. The fields specify: a date 902, data associated with a first and second social network site 904, an aggregated value 906, a stock price 908, event information 910, and alert information 912. The information in the database 900 may be periodically created and updated based on information received from remote social media sources and/or user devices.

The date 902 might, for example, be a date associated that particular row of the table 900. Although the table 900 illustrated in FIG. 9 is updated daily, note that any other periods (or asynchronous updates) might be used instead. The data associated with the first and second social media sources 904 might indicate, for example, a number of posts on a blog or on facebook pages. The aggregated value 906 might indicate the sum, average, or weighted combination of the data 904. Note that the data 904 and aggregated value 906 might be filtered to only include elements associated with a particular entity (or sub-division or product of an entity).

The stock price 908 may reflect the trading price of the company's stock as of the date 902 (or any other financial value associated with the entity, such as a number of shares traded on that day). According to some embodiments, non-financial information may be stored in the database 900. For example, popularity, market share information, polling data, customer satisfaction results, or performance data (e.g., what percent of flight were on time that day) might be stored in the database 900. The event information 910 might indicate one or more events that occurred on the date 902. For example, the event information 910 might reflect that a press release was issued, an earnings report was released, or a product recall was announced on that day. The alert information 912 indicates whether or not an automatic alert was generated and transmitted to one or more users. In the example of FIG. 9, an email alert was automatically generated on Jan. 3, 2011 (perhaps because of an unusually large number of posts that occurred on that day).

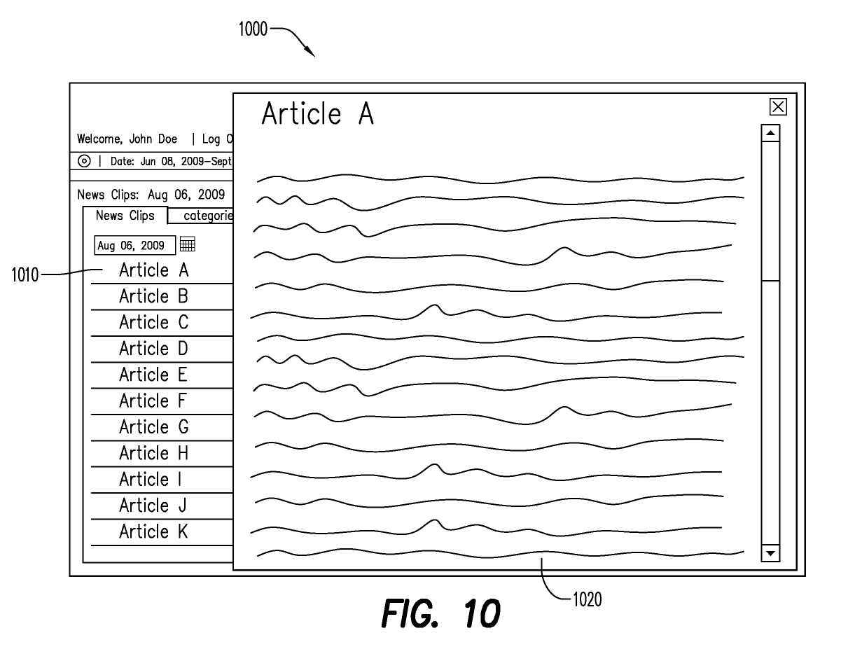

In some cases, a user might want to learn more about the social networking (or other types of information) being presented by the visualization platform. For example, a user might notice a sudden spike in YouTube traffic associated with videos of his or her company the day after a news story appeared. According to some embodiments of the present invention, a user may access an original social networking (or other type of) element via the visualization platform. For example, FIG. 10 illustrates a display 1000 including an original news article 1020 in accordance with some embodiments. The user might, for example, select a brief title or description 1010 when he or she would is interested in viewing the original element 1020 (and perhaps determine why data changed when it did).

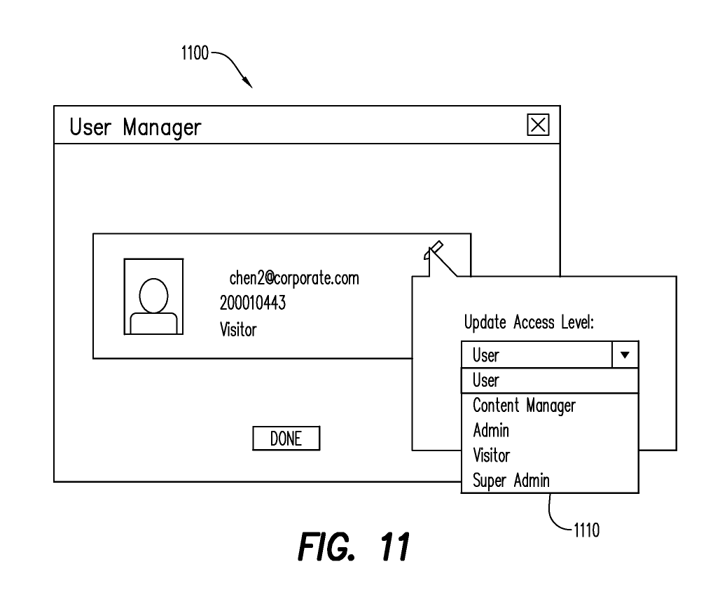

According to embodiments of the present invention, a user may configure and access many different types of displays and information. Note, however, that it might not be appropriate to let all users access all of the types of displays and information that are available in connection with the enterprise. FIG. 11 illustrates access level display 1100 in accordance with some embodiments. In particular, an interface might be used (e.g., by the head of a human resources group) to designate an appropriate level of access for a user in a selection box 1110 (e.g., a regular user, a content manager, and administrator, a visitor, or an administrator with unlimited privileges).

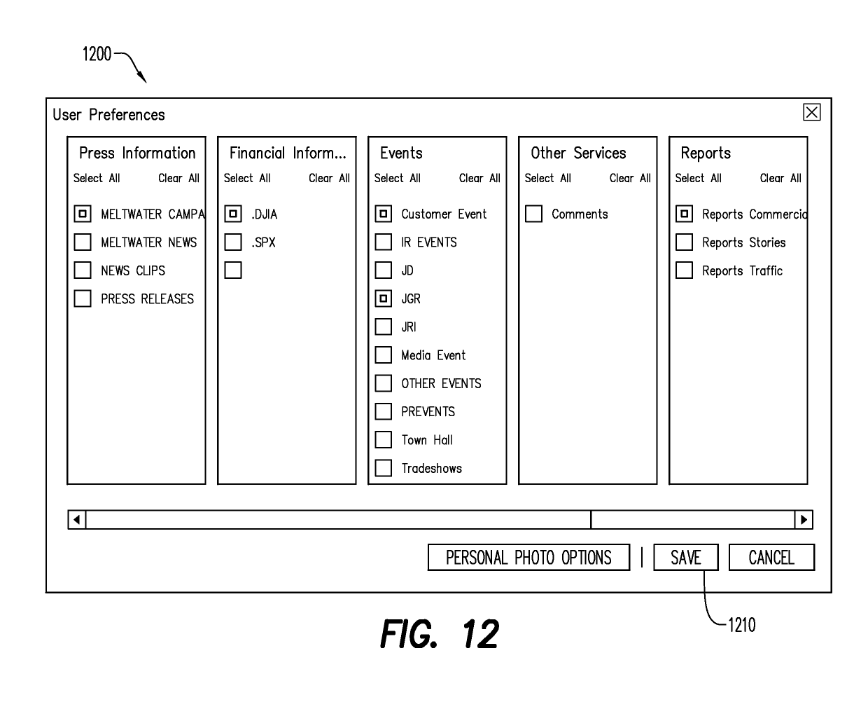

Different users may be interested in seeing different types of information and/or different combinations of data elements. According to some embodiments, a user may save one or more preferred sets of information. For example, FIG. 12 illustrates a user preference display 1200 in accordance with some embodiments. In this case, a user might select various press information, financial information, event, service, and/or report elements and then activate an icon 1210 to save the selections in connection with his or her account.

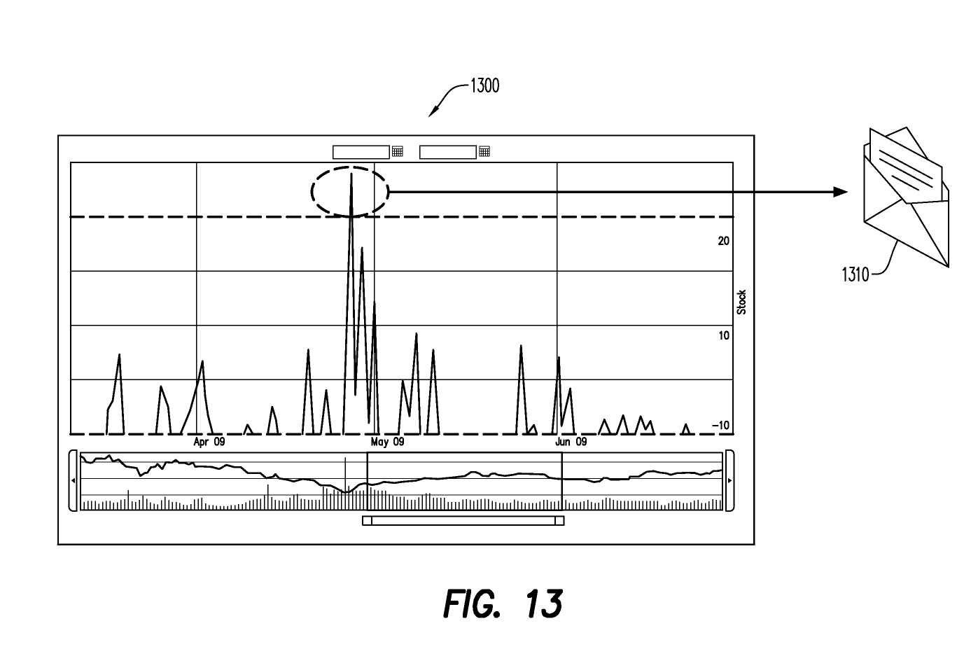

Note that a user might be interested in knowing (in substantially real time) if and when certain social networking parameters exceed (or fall below) a threshold value. According to some embodiments, an alert is automatically transmitted when a social media source data parameter exceeds a user-defined threshold (e.g., when the number of posts is fifty percent higher than average). FIG. 13 illustrates a display 1300 that might be associated with a user alert 1310 in accordance with some embodiments. For example, the visualization platform might provide user boundary anomaly detection wherein user sets upper and lower boundaries for any measurements. When that measurement crosses the boundaries for D consecutive (or total number of) days, an alert might be transmitted to the user. As another example, the visualization platform might provide moving average anomaly detection wherein a user sets moving average on any measurement. If that measurement is above (or below) the moving average by P percentage, an alert might be transmitted to the user.

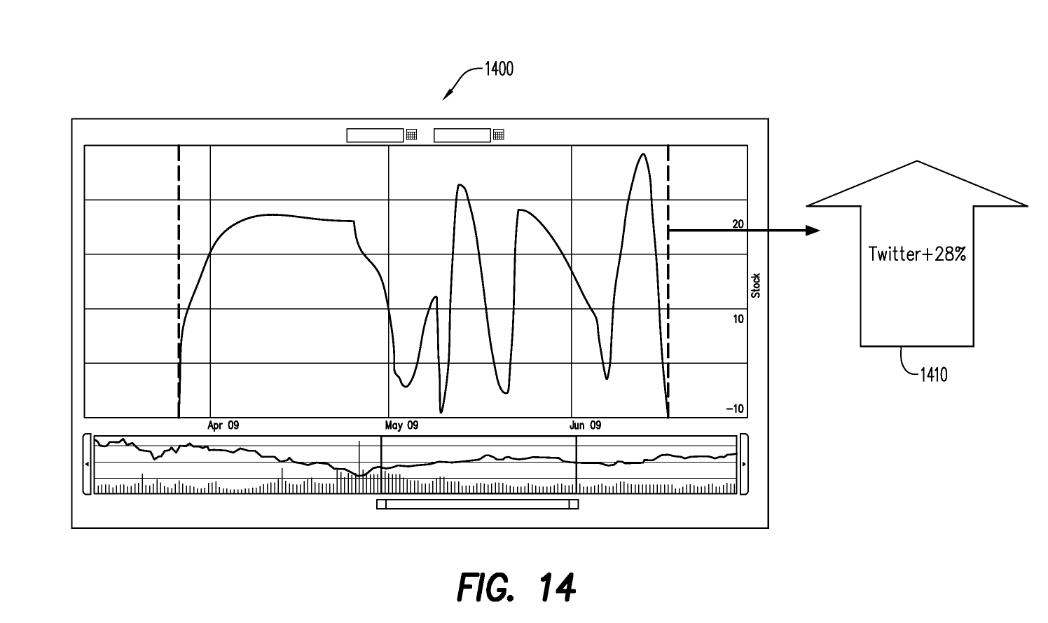

According to some embodiments, a visualization platform might provide automated trend analysis for a user. For example, FIG. 14 illustrates a display 1400 that might be associated with a trend analysis indication 1410 in accordance with some embodiments. In this example, the visualization platform might look for macro and/or micro trends. Moreover, for any measurement the visualization platform could calculate and provide one or more “net change arrows” 1410 during and after campaigns associated with an entity.

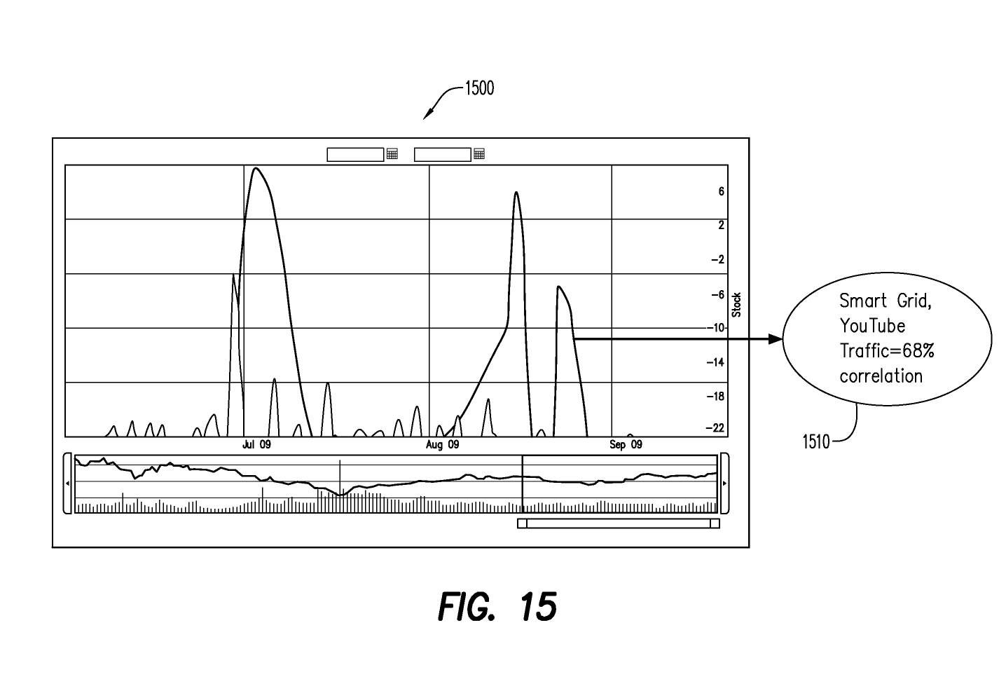

An enterprise might attempt to execute a coordinated campaign in attempt to influence public opinion (and, in particular, activity at social media sources). FIG. 15 illustrates a display 1500 that might be associated with campaign correlations 1510 in accordance with some embodiments. For example, the visualization platform might automatically calculate correlations for campaign such that for any two measurements, an average correlation between specific time periods can be computed and displayed to the user. Note that illustration of FIG. 15 is provided only as a simple example, and that many more combinations and calculations might be possible (e.g., to leverage weighing of different metrics, to combine data with sentiment analysis results, and/or to enable cross-organization collaboration of statistical results).

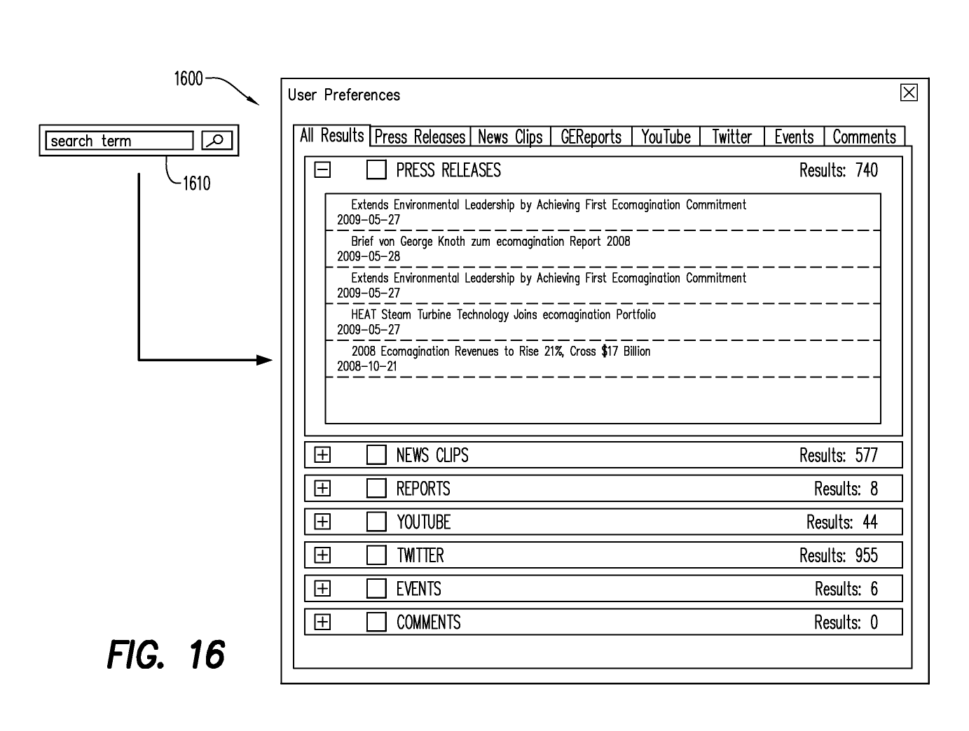

A visualization platform might provide users access to a vast amount of information. In many cases, however, a user may only be interested in information associated with a particular entity, product, or phrase. FIG. 16 illustrates a search display 1600 in accordance with some embodiments. In particular, a user might enter a word or phrase in a search box 1610 and receive a list of search results that satisfy his or her query. A user might select one or more of the search results to view an original social networking item as described with respect to FIG. 10.

As a result of the embodiments described herein, a broad capability to interface, acquire, mine and visualize, analyze, notify, and exchange information (to and/or from any data source) may be provided. The visualization platforms described herein may allow a manual and automated application integration interface that enables the aggregation of substantial, disparate data sources into a holistic, consolidated and/or layered data visualized view which may enable off-line (on demand) and/or on-line (live) data mining, data analysis, data modeling, trending, and/or automated notifications. The visualization platform might also be extended to generate automated responses and actions based on system and user specified rules and behavioral engines.

Note that a visualization platform may effectively present intuitive graph plots of press releases, news feeds, viewership, stock performance, blog comments, Twitter updates, webcasts, events, and/or other social media buzz regarding a company over time to help understand its marketing and communication effectiveness. It may also incorporate advanced weighting and viewership calculations in social media trend analytics to provide apple-to-apple comparisons between a myriad of social media trends for a company. According to some embodiments, a visualization platform may leverage sentiment analysis platforms to provide understanding of public perceptions of a company as well as leverage advanced decision and data mining engine techniques to alert users regarding macro, micro, anomalous, and other special trends within social media measurements (e.g., to better enable users to act upon these trends).

Moreover, some embodiments provide a clear and intuitive user interface that can turn on/off combination of social media measurements, and help a user to drill down to as much details as desired across different timeframes and social media measurements. The various types of superimposed graphs and data described herein may facilitate a user's ability to interpret and understand information associated with social media. According to some embodiments, a user may “plug-in” information about another entity for competitive analysis from social media measurement standpoint. In addition, a user may be able to search for specific social media topics and terminologies.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases and apparatus described herein may be split, combined, and/or handled by external systems).

Applicants have discovered that embodiments described herein may be particularly useful in connection with social and traditional media sources, although embodiments may be used in connection other types of information, such as by providing visualization, decision making, trend analysis, data mining, and/or comparison capabilities for Information Technology (“IT”), security, sourcing, legal, marketing and finance systems.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A data visualization apparatus, comprising:
a communication device to receive data from a plurality of remote data sources, the received data being associated with a plurality of social and traditional media sources;
a processor coupled to the communication device; and
a storage device in communication with said processor and storing instructions adapted to be executed by said processor to:
aggregate the received data based on an association with an entity, and
display to a user at least two superimposed graphs, including (i) a first graph having an x-axis representing time and a y-axis representing an amount of social networking activity in the aggregated data and (ii) a second graph having an x-axis shared with the first graph and a y-axis representing a financial value associated with the entity.

2. The apparatus of claim 1, wherein the entity is associated with at least one of: (i) a company, (ii) a governmental body, (iii) an educational institution, or (iv) an individual.

3. The apparatus of claim 1, wherein the value is associated with at least one of: (i) a financial performance metric(s), key performance indicator(s) (KPI) or (ii) a stock price(s).

4. The apparatus of claim 1, wherein the received data is associated with at least one of: (i) a formal news publication, (ii) a formal press release, (iii) a research article, (iv) social network posts, (v) social network updates, (vi) blog entries, (vii) user comments, (viii) links, or (ix) user connections.

5. The apparatus of claim 1, wherein a third graph is superimposed on the first and second graphs, the third graph having an x-axis shared with the first and second graphs and a y-axis associated with at least one of: (i) a number of press releases, or (ii) a volume of stock trades associated with the entity.

6. The apparatus of claim 1, wherein at least one event indicator is superimposed on the first and second graphs.

7. The apparatus of claim 6, wherein the event indicator is associated with at least one of: (i) a press release, (ii) a news story, (iii) a web cast, (iv) a financial report, or (v) a trade show.

8. The apparatus of claim 1, wherein an alert is automatically transmitted when a social and traditional media source data parameter exceeds a user-defined threshold.

9. The apparatus of claim 1, wherein at least one semi-circle is overlaid on the first and second graphs, the size of the semi-circle being associated with at least one of: (i) a number of comments, or (ii) a number of web page hits.

10. The apparatus of claim 1, wherein an element of received data is weighted based on a number of user-connections associated with the element.

11. The apparatus of claim 1, further comprising at least one of: (i) a dependency graph engine, (ii) a time graph engine, (iii) a table display engine, (iv) a chart engine, (v) a data formatting engine, (vi) a mapping platform, (vii) a visualization engine, (viii) a configuration engine, (ix) a decision engine, (x) a data mining and drilling engine, or (xi) a data source and conversion engine.

12. The apparatus of claim 1, further comprising at least one of: (i) a statistical trending engine, (ii) a sentiment analysis engine, (iii) an alerting engine, or (iv) a collaboration engine.

13. A computer-implemented method, comprising:
receiving data from a plurality of remote data sources, the received data being associated with a plurality of social and traditional media sources;
aggregating the received data based on an association with an entity;
storing the aggregated information; and
automatically displaying to a user at least two superimposed graphs on a user display, including (i) a first graph having an x-axis representing time and a y-axis representing an amount of activity in the aggregated data and (ii) a second graph having an x-axis shared with the first graph and a y-axis representing a financial value associated with the entity.

14. The method of claim 13, wherein a third graph is superimposed on the first and second graphs, the third graph having an x-axis shared with the first and second graphs and a y-axis associated with at least one of: (i) a number of press releases, or (ii) a volume of stock trades associated with the entity.

15. The method of claim 13, wherein at least one event indicator is superimposed on the first and second graphs, the event indicator being associated with at least one of: (i) a press release, (ii) a news story, (iii) a web cast, (iv) a financial report, or (v) a trade show.

16. The method of claim 13, wherein at least one semi-circle is overlaid on the first and second graphs, the size of the semi-circle being associated with at least one of: (i) a number of comments, or (ii) a number of web page hits.

17. A computer-readable medium storing instructions adapted to be executed by a processor to perform a method, said method comprising:
receiving data from a plurality of remote data sources, the received data being associated with a plurality of social and traditional media sources;
aggregating the received data based on an association with an entity;
storing the aggregated information; and
automatically displaying to a user at least two superimposed graphs on a user display, including (i) a first graph having an x-axis representing time and a y-axis representing an amount of activity in the aggregated data and (ii) a second graph having an x-axis shared with the first graph and a y-axis representing a financial value associated with the entity.

18. The medium of claim 17, wherein a third graph is superimposed on the first and second graphs, the third graph having an x-axis shared with the first and second graphs and a y-axis associated with at least one of: (i) a number of press releases, or (ii) a volume of stock trades associated with the entity.

19. The medium of claim 17, wherein at least one event indicator is superimposed on the first and second graphs, the event indicator being associated with at least one of: (i) a press release, (ii) a news story, (iii) a web cast, (iv) a financial report, (v) marketing campaign (vi) stock transaction/issuance/buyback or (vii) a trade show.

20. The medium of claim 17, wherein at least one semi-circle is overlaid on the first and second graphs, the size of the semi-circle being associated with at least one of: (i) a number of comments, or (ii) a number of web page hits.
